(19) United States
(12) Patent Application Publication
(10) Pub. No.: US 2020/0257360 A1
(43) Pub. Date: Aug. 13, 2020

(54) METHOD FOR CALCULATING A GAZE CONVERGENCE DISTANCE

(71) Applicant: Tobii AB, Danderyd (SE)

(72) Inventors: Andreas Klingström, Danderyd (SE); Mattias Brand, Danderyd (SE)

(73) Assignee: Tobii AB, Danderyd (SE)

(21) Appl. No.: 16/726,171

(22) Filed: Dec. 23, 2019

(30) Foreign Application Priority Data
Dec. 21, 2018 (SE) 1851663-3

(51) Int. Cl. G06F 3/01; G06T 19/00

(52) U.S. Cl. CPC G06F 3/013; G06T 19/00

(57) ABSTRACT

The disclosure relates to a method performed by a computer, the method comprising visualizing a plurality of objects, each at a known 3D position, using a 3 display, determining an object of the visualized objects at which a user is watching based on a gaze point, obtaining a gaze convergence distance indicative of a depth the user is watching at, obtaining a reference distance based on the 3D position of the determined object, calculating an updated convergence distance using the obtained gaze convergence distance and the reference distance.

### CROSS-REFERENCES TO RELATED APPLICATIONS

This application claims priority to Swedish Application No. 1851663-3, filed Dec. 21, 2018; the content of which are hereby incorporated by reference.

### TECHNICAL FIELD

The present invention relates to a method performed by a computer, adapted to perform eye gaze tracking, in particular to methods configured to perform eye gaze tracking of a 3D display.

### BACKGROUND

Computer implemented systems and methods are becoming an increasingly important part of most technical fields today. Entire scenes or scenarios simulating an environment of a user may be implemented in virtual reality, VR, applications. In some applications, the virtual environment is mixed with real world representations in so called augmented reality, AR.

Such applications may provide auditory and visual feedback, but may also allow other types of sensory feedback like haptic. Further the user may provide input, typically via a device such as a 3D display (e.g. a so called VR goggles) and/or a handheld control or joystick.

In some applications, the user may receive feedback via a three dimensional 3D display, such as a head mounted and/or stereoscopic display. The 3D display may further comprise sensors capable of detecting gaze convergence distances.

A problem with the detected gaze convergence distance, e.g. comprised in a convergence signal, is that the convergence distance/signal is extremely noisy and deeply dependent on the accuracy of the gaze tracking sensors.

A further problem is that the 3D displays may cause vergence-accommodation conflict, VAC. VAC is related to discrepancies between a distance to an object that the lens is focused on and a distance where gazes of both eyes converge or where the directional angle of the eyes converge.

Thus, there is a need for an improved method for calculating a gaze convergence distance.

### OBJECTS OF THE INVENTION

An objective of embodiments of the present invention is to provide a solution which mitigates or solves the drawbacks described above.

### SUMMARY OF THE INVENTION

The above objective is achieved by the subject matter described herein. Further advantageous implementation forms of the invention are described herein.

According to a first aspect of the invention the objects of the invention is achieved by a method performed by a computer, the method comprising visualizing a plurality of objects, each at a known 3D position, using a 3D display, determining an object of the visualized objects at which a user is watching based on a gaze point, obtaining a gaze convergence distance indicative of a depth the user is watching at, obtaining a reference distance based on the 3D position of the determined object, calculating an updated convergence distance using the obtained gaze convergence distance and the reference distance.

At least one advantage of of the first aspect of the invention is that object determination/selection can be approved. A further advantage is that problems due to vergence-accommodation conflict can be reduced.

According to a second aspect of the invention, the objects of the invention is achieved by a computer, the computer comprising an interface to a 3D display, a processor; and a memory, said memory containing instructions executable by said processor, whereby said computer is operative to visualize a plurality of objects, each at a known 3D position, using the 3D display by sending a control signal to the 3D display, determine an object of the visualized objects at which a user is watching based on a gaze point, obtaining a gaze convergence distance indicative of a depth the user is watching at, obtain a reference distance based on the 3D position of the determined object and calculating an updated convergence distance using the obtained gaze convergence distance and the reference distance.

The advantages of the second aspect are at least the same as for the first aspect.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a cross-sectional view of an eye.

FIG. 2A-B shows a head-mounted device and a remote display according to one or more embodiments of the present disclosure.

FIG. 3 is a schematic overview of a system for calculating or determining a convergence distance according to one or more embodiments of the present disclosure.

FIG. 4 shows a computer according to one or more embodiments of the present disclosure.

FIGS. 5A and 5B illustrates determination of a gaze point according to one or more embodiments.

FIG. 6 illustrates a measurement distribution comprising a number of gaze points.

FIG. 7 shows a flowchart of a method according to one or more embodiments of the present disclosure.

FIG. 8 illustrates a convergence distance calculated based on visual axes according to one or more embodiments of the present disclosure.

FIG. 9 illustrates a convergence distance calculated based on interocular distance and interpupillary distance according to one or more embodiments of the present disclosure.

FIG. 10A-B illustrates visualization of a plurality of objects according to one or more embodiments of the present disclosure.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

In the present disclosure, the term three dimensional, 3D, display denotes a display or device capable of providing a user with a visual impression of viewing objects in 3D. Examples of such 3D displays include stereoscopic displays, shutter systems, polarization systems, interference filter systems, color anaglyph systems, Chromadepth systems, autostereoscopic display, holographic displays, volumetric displays, integral imaging displays or wiggle stereoscopy displays.

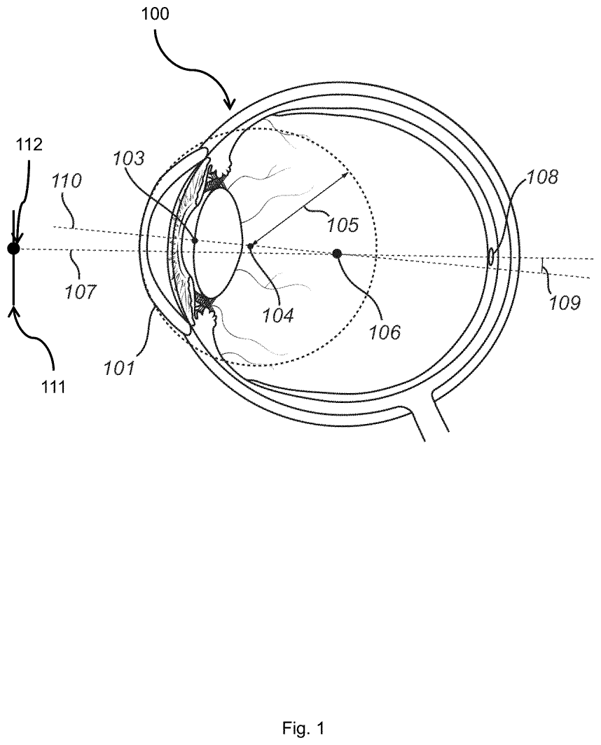

FIG. 1 shows a cross-sectional view of an eye 100. The eye 100 has a cornea 101 and a pupil 102 with a pupil center 103. The cornea 101 is curved and has a center of curvature 104 which is referred as the center 104 of corneal curvature, or simply the cornea center 104. The cornea 101 has a radius of curvature referred to as the radius 105 of the cornea 101, or simply the cornea radius 105. The eye 100 has a center 106 which may also be referred to as the center 106 of the eye ball, or simply the eye ball center 106. The visual axis 107 of the eye 100 passes through the center 106 of the eye 100 to the fovea 108 of the eye 100. The optical axis 110 of the eye 100 passes through the pupil center 103 and the center 106 of the eye 100. The visual axis 107 forms an angle 109 relative to the optical axis 110. The deviation or offset between the visual axis 107 and the optical axis 110 is often referred to as the fovea offset 109. In the example shown in FIG. 1, the eye 100 is looking towards a display 111, and the eye 100 is gazing at a gaze point 112 at the display 111. FIG. 1 also shows a reflection 113 of an illuminator at the cornea 101. Such a reflection 113 is also known as a glint.

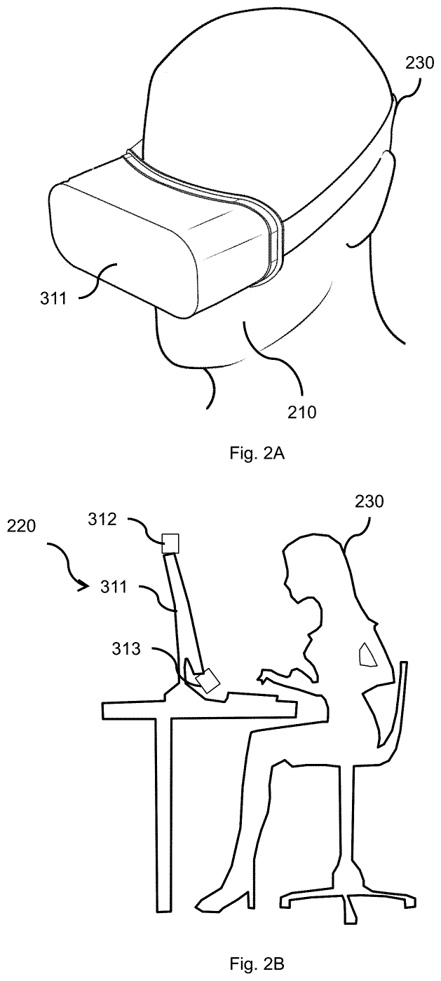

FIG. 2A shows a head-mounted device 210 according to one or more embodiments. The head-mounted device 210, is a device which may optionally be adapted to be mounted (or arranged) at the head of a user 230, as shown in FIG. 2A. The head-mounted device 210 may e.g. comprise and/or be comprised in a head-mounted display (HMD) such as a virtual reality (VR) headset, an augmented reality (AR) headset or a mixed reality (MR) headset. The head-mounted device 210 or head-mounted display, HMD, comprises a 3D display 311, which is able to visualize a plurality of objects 1011, 1021, 1031 in response to a control signal received from a computer. The head-mounted device 210 is typically further configured to provide a gaze tracking signal using one or more gaze tracking sensors, e.g. indicative of a gaze point and/or a convergence distance. In other words, the head-mounted device 210 is configured to provide an indication of an object the user is looking at and/or a depth at which the user is looking/watching.

The 3D display may for example be a stereoscopic display. The 3D display may for example be comprised glasses equipped with AR functionality. Further, the 3D display may be a volumetric 3D display, being either autostereoscopic or automultiscopic, which may indicate that they create 3D imagery visible to an unaided eye, without requiring stereo goggles or stereo head-mounted displays. Consequently, as described in relation to FIG. 2, the 3D display may be part of the head-mounted device 210. However, the 3D display may also be a remote display, which does not require stereo goggles or stereo head-mounted displays. In a third example, the 3D display is a remote display, where stereoscopic glasses are needed to visualize the 3D effect to the user.

FIG. 2B shows a remote display system 220 according to one or more embodiments. The remote display system 220 typically comprises a remote 3D display 311, as described in relation to FIG. 2A. The 3D display 311 is remote in the sense that it is not located in the immediate vicinity of the user 230. The remote display system 220 is typically further configured to provide a gaze tracking signal using one or more gaze tracking sensors 312, 313, e.g. indicative of a gaze point and/or a convergence distance. In other words, the remote display system 220 is configured to provide an indication of an object the user 230 is looking at and/or a depth at which the user is looking/watching. As can be seen from FIG. 2B, the remote 3D display 311 does not require stereo/stereoscopic goggles or stereo/stereoscopic head-mounted displays. In a further example, the 3D display is a remote display, where stereoscopic glasses are needed to visualize the 3D effect to the user.

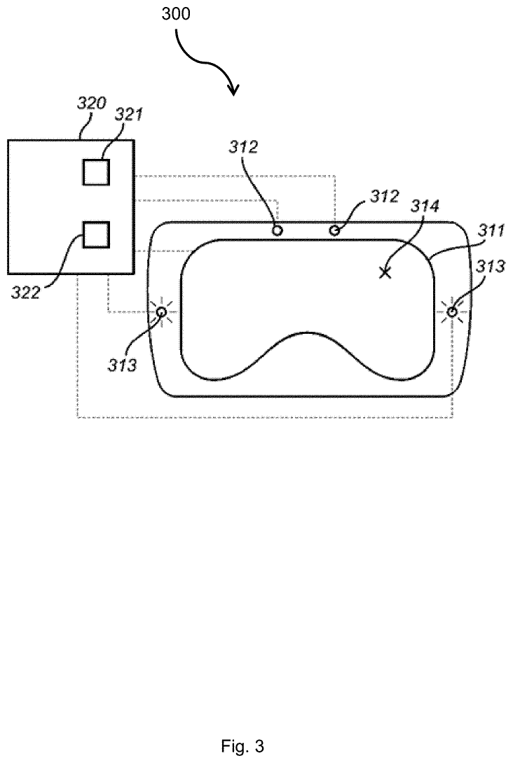

FIG. 3 is a schematic overview of a system 300 for calculating or determining a convergence distance according to one or more embodiments. The system may comprise a 3D display 311, 1000, and a computer 320. The 3D display 311, 1000, may comprise one or more displays. The 3D display 311, 1000, may for example comprise a single display which is intended to be positioned in front of the user's eyes, or the 3D display 311, 1000, may be a stereoscopic display that comprises separate displays for each eye 100 and is intended to be positioned in front of a user's 230 left and/or right eye respectively. Alternatively, the 3D display 311, 1000, could comprise a single display adapted to be arranged in front of one of the user's eyes, so that one eye can watch the display of the head-mounted device while the other eye can watch the real world surroundings.

The 3D display 311, 1000, may comprise one or more gaze tracking sensors. The one or more gaze tracking sensors may comprise one or more cameras 312 for capturing images of the user's eyes while the user looks at the 3D display 311, 1000. The gaze tracking sensors may also comprise one or more illuminators 313 for illuminating the eyes of the user. The camera(s) 312 and illuminator(s) 313 may for example be employed for eye gaze tracking. The gaze tracking may for example involve estimating a gaze direction (corresponding to the visual axis 107), a gaze convergence distance/convergence distance and/or estimating a gaze point 112.

The 3D display 311, 1000, may for example be comprised in the system 300, or may be regarded as separate from the system 300, e.g. a remote display as further described in relation to FIG. 2B.

The system 300 comprises the computer 320 which is configured to estimate/determined/calculate a convergence distance. The computer 320 may further be configured to visualize a plurality of objects by sending a control signal to the 3D display 311, 1000. The computer 320 may further be configured to obtain a gaze tracking signal or control signal from the the tracking sensors 312, 313, e.g. indicative of a gaze point and/or a convergence distance. In other words, the computer 320 is configured to obtain an indication of an object the user is looking at and/or an indication of a depth at which the user is looking/watching.

The computer 320 may for example also be configured to estimate a gaze direction (or gaze vector) of an eye 100 (corresponding to a direction of the visual axis 107), or a gaze point 112 of the eye 100.

The computer 320 may for example be integrated with the 3D display 311, 1000, or may be separate from the 3D display 311, 1000. The computer 320 may further for example be integrated with the one or more gaze tracking sensors 312, 313, or may be separate from the one or more gaze tracking sensors 312, 313. The computer 320 may be communicatively connected to the 3D display 311, 1000 and/or the one or more gaze tracking sensors 312, 313, for example via a wired or wireless connection. For example, the computer 320 may be communicatively connected to a selection of any of the camera(s) 312, to the 3D display 311 and/or to the illuminator(s) 313. The computer 320 may further configured to control or trigger the 3D display 311 to show test stimulus points 314 for calibration of gaze tracking.

The camera(s) 312 and/or illuminator(s) 313 may for example be infrared or near infrared illuminators, for example in the form of light emitting diodes (LEDs). However, other types of illuminators may also be envisaged. FIG. 3 shows example camera(s) 312 and/or illuminators 313 located at either side of the display 311, but the camera(s) 312 and/or illuminators 313 could be located elsewhere. The 3D display 210 may for example comprise illuminators 313 distributed around the display 311. The cameras 312 and/or illuminators 313 could additionally or alternatively be located remote from the user 230, e.g. at the remote 3D display.

The cameras 312 may for example be charged-coupled device (CCD) cameras or Complementary Metal Oxide Semiconductor (CMOS) cameras. However, other types of cameras may also be envisaged.

The 3D display 311 may for example comprise one or more liquid-crystal displays (LCD) or one or more LED displays. However, other types of displays may also be envisaged. The 3D display may 311 may for example be flat or curved. The 3D display 311 may for example be placed in front of one of the user's eyes. In other words, separate displays may be employed for the left and right eyes. Separate equipment/one or more gaze tracking sensors (such cameras 312 and illuminators 313) may for example be employed for the left and right eyes.

A single computer 320 may be employed or a plurality of computers may cooperate to perform the methods described herein. The system 300 may for example perform gaze tracking for the left and right eyes separately, and may then determine a combined gaze point as an average of the gaze points determined for the left and right eyes.

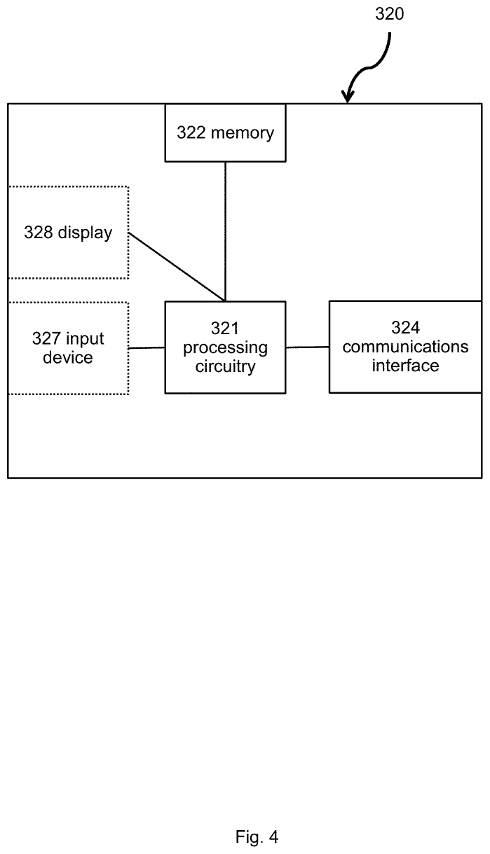

Details of the computer are further described in relation to FIG. 4.

It will be appreciated that the system 300 described above with reference to FIG. 3 is provided as an example, and that many other systems may be envisaged. For example, the one or more gaze tracking sensors, such as illuminator(s) 313 and/or the camera(s) 312, need not necessarily be regarded as part of the system 300. The system 300 may for example consist only of the 3D display 311 and/or the computer 320.

FIG. 4 shows a computer 320 according to an embodiment of the present disclosure. The computer 320 may be in the form of a selection of any of one or more Electronic Control Units, a server, an on-board computer, an digital information display, a stationary computing device, a laptop computer, a tablet computer, a handheld computer, a wrist-worn computer, a smart watch, a PDA, a Smartphone, a smart TV, a telephone, a media player, a game console, a vehicle mounted computer system or a navigation device. The computer 320 may comprise processing circuitry 321.

The computer 320 may further comprise a communications interface 324, e.g. a wireless transceiver 324 and/or a wired/wireless communications network adapter, which is configured to send and/or receive data values or parameters as a signal to or from the processing circuitry 321 to or from other computers and/or to or from other communication network nodes or units, e.g. to/from the gaze tracking sensors 312, 313 and/or to/from the 3D display 311 and/or to/from a server. In an embodiment, the communications interface 324 communicates directly between control units, sensors and other communication network nodes or via a communications network. The communications interface 324, such as a transceiver, may be configured for wired and/or wireless communication. In embodiments, the communications interface 324 communicates using wired and/or wireless communication techniques. The wired or wireless communication techniques may comprise any of a CAN bus, Bluetooth, WiFi, GSM, UMTS, LTE or LTE advanced communications network or any other wired or wireless communication network known in the art.

Further, the communications interface 324 may further comprise at least one optional antenna (not shown in figure). The antenna may be coupled to the communications interface 324 and is configured to transmit and/or emit and/or receive a wireless signals in a wireless communication system, e.g. send/receive control signals to/from the one or more sensors, the 3D display 311 or any other control unit or sensor.

In one example, the processing circuitry 321 may be any of a selection of processor and/or a central processing unit and/or processor modules and/or multiple processors configured to cooperate with each-other. Further, the computer 320 may further comprise a memory 322.

In one example, the one or more memory 322 may comprise a selection of a hard RAM, disk drive, a floppy disk drive, a magnetic tape drive, an optical disk drive, a CD or DVD drive (R or RW), or other removable or fixed media drive. The memory 322 may contain instructions executable by the processing circuitry to perform any of the methods and/or method steps described herein.

In one or more embodiments the computer 320 may further comprise an input device 327, configured to receive input or indications from a user and send a user-input signal indicative of the user input or indications to the processing circuitry 321.

In one or more embodiments the computer 320 may further comprise a display 328 configured to receive a display signal indicative of rendered objects, such as text or graphical user input objects, from the processing circuitry 321 and to display the received signal as objects, such as text or graphical user input objects.

In one embodiment the display 328 is integrated with the user input device 317 and is configured to receive a display signal indicative of rendered objects, such as text or graphical user input objects, from the processing circuitry 321 and to display the received signal as objects, such as text or graphical user input objects, and/or configured to receive input or indications from a user and send a user-input signal indicative of the user input or indications to the processing circuitry 321. In embodiments, the processing circuitry 321 is communicatively coupled to the memory 322 and/or the communications interface 324 and/or the input device 327 and/or the display 328 and/or one or more gaze tracking sensors. The computer 320 may be configured to receive the sensor data directly from a sensor or via the wired and/or wireless communications network.

In a further embodiment, the computer 320 may further comprise and/or be coupled to one or more additional sensors (not shown) configured to receive and/or obtain and/or measure physical properties pertaining to the user or environment of the user and send one or more sensor signals indicative of the physical properties to the processing circuitry 321, e.g. sensor data indicative of a position a head of the user.

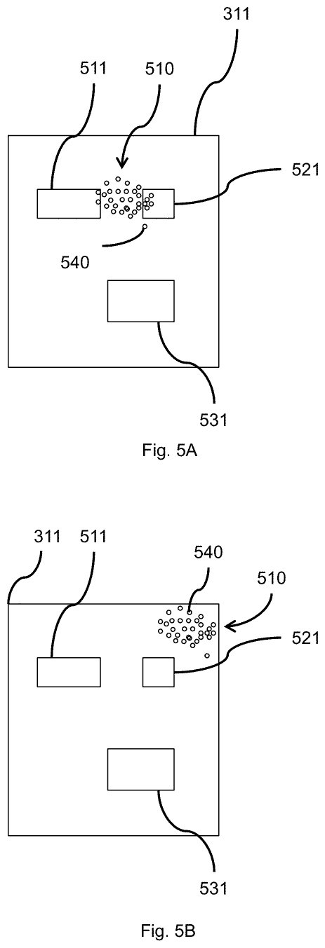

FIGS. 5A and 5B illustrates determination of a gaze point 540 according to one or more embodiments. The method described herein relates to analysis of a gaze point 540 of a user interacting with a computer-controlled system using gaze tracking functionality. Using the gaze point 540, an object 511 of a plurality of visualized objects 511, 521, 331 at which a user is watching can be determined or selected or identified. The term visualized object may refer to any visualized object or area in visualization that a user of the computer-controlled system may direct its gaze at. In the present disclosure, two or more consecutive measured and/or determined gaze points may be referred to as a measurement distribution 510, for example having the shape of a “gaze point cloud” 510, as shown in FIGS. 5A and 5B.

FIG. 5A shows a 3D display 311 comprising or visualizing three visualized objects 511, 521, 531 and a measurement distribution 510, wherein the measurement distribution comprises a number of measured gaze points/positions on the display 311, illustrated as points in the distribution 510 in FIGS. 5A and 5B.

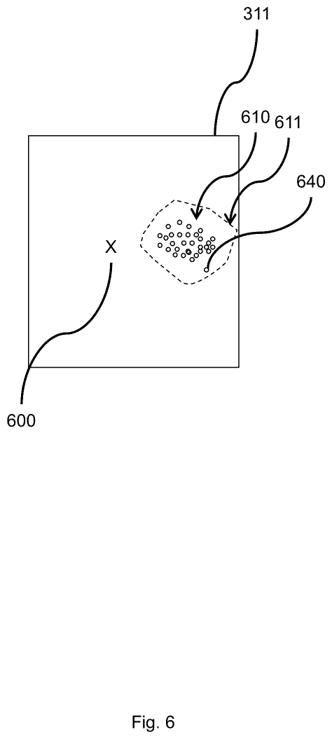

FIG. 6 illustrates a measurement distribution comprising a number of measured and/or calculated, gaze points. More specifically, in FIG. 6 a measurement distribution 610 comprising a number of measured, or calculated, gaze points 640 are shown, along with an actual gaze point 600, in other words the point or position in the 3D display 311 at which the user is actually looking at. The 3D display 311 may of course comprise any suitable number of visualized objects. As can be seen from FIG. 6, an actual gaze point 600 may not be within the borders of the measured gaze distribution 610. This is caused by an offset between the actual gaze point 600 and the measurement distribution 610.

The measurement distribution of gaze points 510 in FIG. 5A is positioned partly on and between the visualized objects 511, 521, 531.

In some situations, the measured gaze points of the distribution 510/610 are not all positioned on a visualized object but positioned partly on and between the two or more visualized objects 511, 521. In one or more embodiments the step of determining or identifying one object from the visualized objects 511, 521, 531 then comprises calculating all measured gaze points falling within perimeters of the object of each of the visualized objects 511, 521, 531 and/or determining a selection area in which all the measured gaze points reside, e.g. the area 611 indicated by a dashed line in FIG. 6. The method may further comprise selecting, determining or identifying the object of the visualized objects 511, 521, 531 that has the largest amount of overlapping measured gaze points within the perimeter of the object, or selecting, determining or identifying the object where the perimeter of the object has the largest overlapping area, i.e. the largest area formed by the perimeter of the object and overlapping with the selection area 611.

A selection area 611 in the context of the invention is an area defined for a specific object, wherein the selection area at least partly overlaps the area of the object. Typically, the selection area coincides with or comprises the area of the object. The size of the selection area depends on the weighting of the object, based on the properties of the interaction element, the interaction context, the psychological properties of the user and the physiological properties of the human eye. The interaction context relates to how an interaction element is used by the user in the current context. The current context may in this case be that the user is looking/searching for something presented on the display, wanting to activate a certain function, wanting to read, pan or scroll, or the like. For example, if it is known that the user wants to select or activate an object, by the user providing manual input indicating this, through statistics based assumption or the like, any selectable object may for instance be assigned higher weights or highlighted in the visualization so that it is easier for the user to select them. Other objects, such as scroll areas, text areas or images, may in this context be assigned lower weights or inactivated. In another example, if the user is reading a text, panning or scrolling, again known from user input, through statistics based assumption or the like, any selectable object may be assigned low weights or inactivated, and/or any highlights may be removed, so that the user is not distracted.

In one embodiment, the object that is connected to the selection area is selected if the gaze of the user is measured or determined to be directed at a point within the defined selection area.

In embodiments, the step of determining an object 511 of the visualized objects 511, 521, 531 at which a user is watching based on a gaze point 540, 640 comprises calculating all measured gaze points and/or the area in which all the measured gaze points reside. In embodiments, the method further comprises selecting, determining or identifying an object that has within the borders of the object, or within the borders of the defined selection area: the largest amount of overlapping measured gaze points, or the largest area that coincides with the area in which all the measured gaze points reside.

Due to the possible offset between the actual gaze point and the measured gaze points the use of this method alone may in some cases lead to determination of the wrong interaction element. The method may advantageously be combined with other method embodiments herein to provide further improved results.

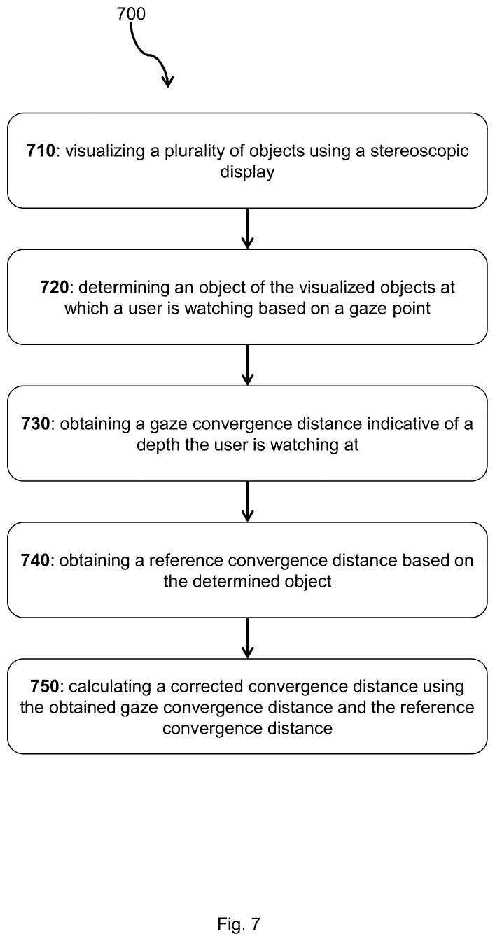

FIG. 7 shows a flowchart of a method according to one or more embodiments of the present disclosure. The method 300 may be performed by a computer 320 and the method comprises:

Step 710: visualizing a plurality of objects 511, 521, 531 using a 3D display 311, 100. Each of the plurality of objects 511, 521, 531 may be visualized at a known three dimensional, 3D, position.

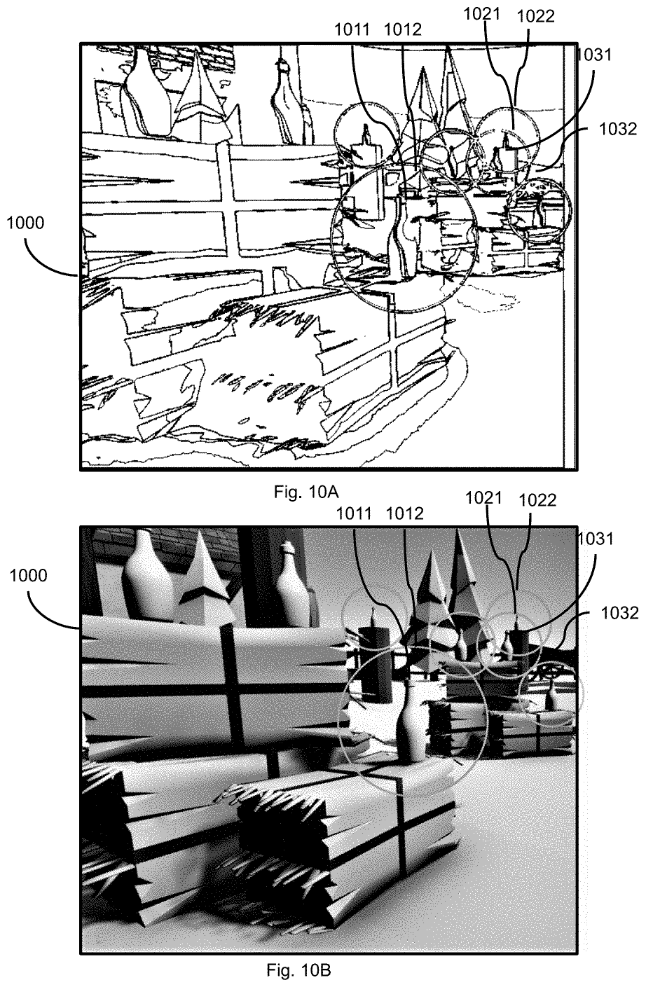

An example of visualizing a plurality of objects 511, 521, 531 is further described in relation to FIG. 10A-B. As further described above, the plurality of objects 511, 521, 531 may be visualized using a head mounted display 210.

Step 720: determining an object 511 of the visualized objects 511, 521, 531 at which a user is watching based on a gaze point. Determining the object 511 is further described in relation to FIG. 5 and FIG. 6.

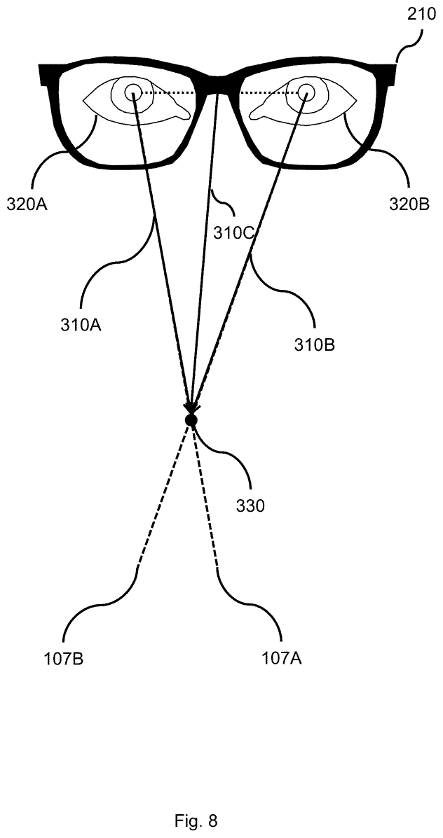

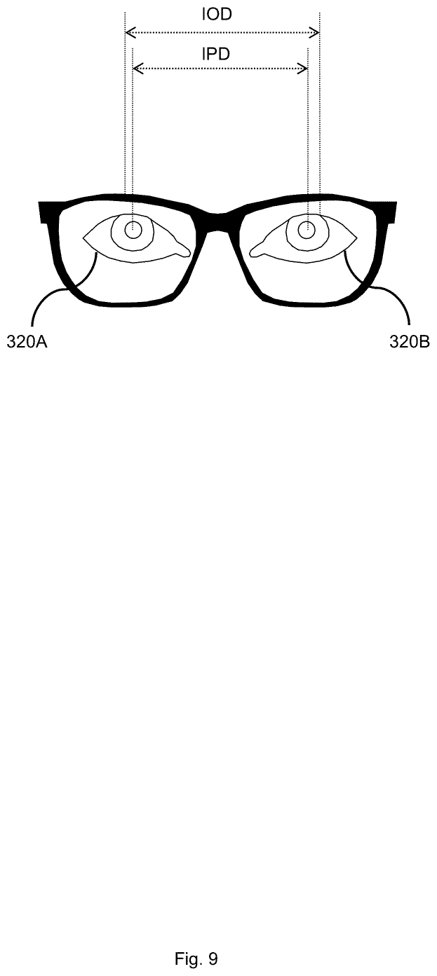

Step 730: obtaining gaze convergence distance indicative of a depth the user is watching at. Obtaining gaze convergence distance is further described in relation to FIG. 8 and FIG. 9.

Step 740: obtaining a reference distance and/or a reference convergence distance based on the determined object 511. The reference distance and/or a reference convergence distance may further be based on the 3D position of the determined object 511.

In one example, the determined object 511 is associated with an object identity, ID, a coordinate system and/or a three dimensional model and a position of the object relative to the user of the 3D display 311, 1000. The reference convergence distance can then be calculated and/or determined as a Euclidian distance or length of a vector from a position of the user/3D display 311, 1000 to the position of the object.

Step 750: calculating an updated convergence distance using the obtained gaze convergence distance and the reference convergence distance.

In one embodiment, the corrected convergence distance is calculated as being equal to the reference convergence distance. In one embodiment, the method further comprises calculating a difference value as a difference between the obtained gaze convergence distance and the reference distance and/or the reference convergence distance. In one or more embodiments, the method further comprises calibrating one or more gaze tracking sensors 312, 313 using the difference value. Calibrating one or more gaze tracking sensors is further displayed in relation to FIG. 8 and FIG. 9.

According to some aspects of the invention, the visualized objects 511, 521, 531 are being visualized using a 3D display 311, 1000, such as a multifocal stereoscopic display. When using 3D displays, the user often perceives distortions of visualized objects compared with the percepts of the intended object. A likely cause of such distortions is the fact that the computer visualizes images on one surface, such as a screen. Thus, the eye focuses on the depth of the display rather than the depths of objects in a depicted scene. Such uncoupling of vergence and accommodation, also denoted vergence-accommodation conflict, reduces the user's ability to fuse the binocular stimulus and causes discomfort and fatigue for the viewer.

The present disclosure solves this by selecting a focal-plane of a multifocal 3D display, having a plurality of focal-planes, using the updated convergence distance. This has the advantage that effects of vergence-accommodation conflict is reduced, that the time required to identify a stereoscopic stimulus is reduced, stereo-acuity in a time-limited task is increased, distortions in perceived depth are reduced, and user fatigue and discomfort are reduced.

Therefore, in one embodiment, the method further comprises selecting a focal-plane of a multifocal 3D display display 311, 1000 using the updated convergence distance.

According to a further aspect of the invention, the updated convergence distance is used for subsequent determination of an object 511 selected from the visualized objects 511, 521, 531. In one embodiment, the method in FIG. 7 further comprises subsequently determining a further object 321, 331 of the visualized objects 511, 521, 531 using the updated convergence distance.

With reference to FIG. 10A-B, in one example two visualized objects 1021, 1031 may be located relatively close to each other in a plane formed by X-Y axes but separated in depth or along the Z axis. The updated convergence distance may either be used to calibrate one or more gaze tracking sensors and the gaze convergence distance and/or the updated convergence distance may be used to distinguish or select an object from the two visualized objects 1021, 1031.

As mentioned previously, each eye can be seen as having a visual axis 107. When the user is watching an object, both visual axes will converge, intersect or reach a minimal distance in 3D space in case they do not intersect, which is usual if seen in 3D, thereby defining a convergence point 330. According to one aspect of the invention, the gaze convergence distance can e.g. be calculated from an eye 320A, 320B to a convergence point 330 or by calculating a depth 310C from a normal between a first eye 320A and a second eye 320B to the convergence point 330.

FIG. 8 illustrates a convergence distance calculated based on visual axes according to one or more embodiments of the present disclosure. In the figure, a user has two eyes 320A, 320B and is using a 3D display 311, 1000, such as a stereoscopic display, a remote eye tracking device and/or a remote display. Each eye can be associated with a visual axis 107A, 107B. A convergence point 330 can be determined as the point of intersection of the axes 107A, 107B. A depth 310A-C can then be calculated from the user to the convergence point 330. The gaze convergence distance can be calculated as a depth/distance 310A from a first eye 320A to the convergence point 330, can be calculated as a depth/distance 3108 from a second eye 320B to the convergence point 330 or by calculating a depth/distance 310C from a normal between the first eye 320A and the second eye 320B to the convergence point 330.

FIG. 9 illustrates a convergence distance calculated based on interocular distance, IOD, and interpupillary distance, IPD, according to one or more embodiments of the present disclosure. In one embodiment, the gaze convergence distance is obtained using an interocular distance (IOD), indicating a distance between the eyes of the user, and an interpupillary distance (IPD), indicating a distance between the pupils of the user, and a predetermined function.

In one example, the predetermined function is implemented in the form of a look-up table or other data structure capable to identify a particular convergence distance using a pair of IOD and IPD values. The look-up table or other data structure may be built up or created by monitoring measured IOD and IPD values whilst allowing a user to focus on objects at different depths.

With reference to FIG. 4, in other aspects of the present disclosure a computer 320 is provided. The computer comprises an interface 324 to a 3D display and/or 3D display 210. In embodiments, the 3D display 210 may be comprised in the computer or the computer may be comprised in the 3D display 210. The computer further comprises a processor 321 and a memory 322, said memory containing instructions executable by said processor 321, whereby said computer is operative to visualize a plurality of objects 511, 521, 531, each at a known, three dimensional, 3D, position, using the 3D display 210 by sending a control signal to the 3D display 210. The computer is further operative to determine an object 511 of the visualized objects 511, 521, 531 at which a user is watching based on a gaze point. The computer is further operative to obtain a gaze convergence distance indicative of a depth the user is watching at, obtain a reference distance based on the 3D position of the determined object 511, calculating an updated convergence distance using the obtained gaze convergence distance and the reference distance.

In one embodiment the 3D display 311, 1000 comprises a multifocal 3D display, wherein the computer is further configured to select a focal-plane of the 3D display 311, 1000 using the updated convergence distance.

In one embodiment, the computer 320 is further configured to subsequently determine a further object 521, 531 of the visualized objects 511, 521, 531 using the updated convergence distance.

In one embodiment, the computer 320 is further configured to obtain the gaze convergence distance by calculating a depth 310A, 310B from an eye 320A, 320B to a convergence point 330 or by calculating a depth 310C from a normal between the first eye 320A and the second eye 320B to the convergence point 330.

In one embodiment, the computer 320 is further configured to obtain the gaze convergence distance by using an interocular distance IOD, indicating a distance between the eyes of the user, and an interpupillary distance IPD, indicating a distance between the pupils of the user, and a predetermined function.

In one embodiment, a computer program is provided and comprising computer-executable instructions for causing the computer 320, when the computer-executable instructions are executed on a processing unit comprised in the computer 320, to perform any of the method steps of the methods described herein.

In one embodiment, a computer program product is provided and comprising a computer-readable storage medium, the computer-readable storage medium having the computer program above embodied therein.

FIG. 10A-B illustrates visualization of a plurality of objects 1011, 1021, 1031 by a 3D display 1000 according to one or more embodiments of the present disclosure. FIG. 10A shows a vector image version of the visualization and FIG. 10B shows a greyscale image version of the visualization. The visualization of objects by the 3D display depicts a scene with bottles placed on various other objects or items. Each object 1011, 1021, 1031 is associated with an object identity, ID and a 3D position of a coordinate system and/or a three dimensional model. Each object 1011, 1021, and 1031 may further be associated to a selection area 1012, 1022, 1032, as further described in relation to FIG. 5 and FIG. 6.

In one example, the 3D position of an object is converted to a position in a display for the left eye using a first projection and converted to a position in a second display for the left eye using a second projection, thereby visualizing the object in 3D to the user 230.

An object 1011 of the visualized objects 1011, 1021, 1031 at which a user is watching is determined based on a gaze point, as further described in relation to FIG. 5 and FIG. 6. In this example, it may be determined that the user is watching a bottle 1011, as a gaze point or a majority of gaze points falls within a selection area 1012 associated with the bottle. A gaze convergence distance indicative of a depth the user is watching at is then obtained, e.g. by analyzing output of a predetermined function/relation in response to a registered IPD/IOD value pair. A reference distance is then obtained based on the 3D position of the determined object 1011. E.g. by calculating a Euclidian distance or vector from an eye 320A-B of the user to a convergence point of visual axes of the eyes 320A and 320B. An updated convergence distance is then calculated using the obtained gaze convergence distance and the reference distance, i.e. by updating the obtained gaze convergence distance with the reference distance.

In a subsequent visualization of the objects, any one of the visualized objects 1011, 1021, 1031 may be visualized using a focal-plane of a multifocal 3D display 1000, the focal plane being selected using the updated convergence distance, e.g. a focal-plane with the closest depth/distance to minimize VAC.

In a subsequent visualization of the objects, any one of the visualized objects 1011, 1021, 1031 may be determined using the updated convergence distance. E.g. by obtaining a more accurate determination by using one or more gaze tracking sensors 312, 313 calibrated using the updated convergence distance.

In embodiments, the communications network communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

Moreover, it is realized by the skilled person that the computer 320 may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, encoder, decoder, power supply units, power feeders, communication interfaces, communication protocols, etc. which are suitably arranged together for performing the present solution.

Especially, the processing circuitry of the present disclosure may comprise one or more instances of processor and/or processing means, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA) or other processing logic that may interpret and execute instructions. The expression “processing circuitry” may thus represent a processing circuitry comprising a plurality of processing circuits, such as, e.g., any, some or all of the ones mentioned above. The processing means may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A method performed by a computer, the method comprising:
visualizing a plurality of objects, each at a known 3D position, using a 3D display,
determining an object of the visualized objects at which a user is watching based on a gaze point,
obtaining a gaze convergence distance indicative of a depth the user is watching at,
obtaining a reference distance based on the 3D position of the determined object,
calculating an updated convergence distance using the obtained gaze convergence distance and the reference distance.

2. The method according to claim 1, further comprising selecting a focal-plane of a multifocal 3D display using the updated convergence distance.

3. The method according to claim 1, further comprising subsequently determining a further object of the visualized objects using the updated convergence distance.

4. The method according to claim 1, wherein the gaze convergence distance is obtained by calculating a depth from an eye to a convergence point or by calculating a depth from a normal between a first eye and a second eye to the convergence point.

5. The method according to claim 1, wherein the gaze convergence distance is obtained using an interocular distance (IOD), indicating a distance between the eyes of the user, and an interpupillary distance (IPD), indicating a distance between the pupils of the user, and a predetermined function.

6. A computer, the computer comprising:
an interface to a three dimensional, 3D, display,
a processor; and
a memory, said memory containing instructions executable by said processor, whereby said computer is operative to:
visualize a plurality of objects, each at a known three dimensional, 3D, position, using the 3D display by sending a control signal to the 3D display,
determine an object of the visualized objects at which a user is watching based on a gaze point,
obtaining a gaze convergence distance indicative of a depth the user is watching at,
obtain a reference distance based on the 3D position of the determined object,
calculating an updated convergence distance using the obtained gaze convergence distance and the reference distance.

7. The computer according to claim 6, wherein the 3D display is a multifocal 3D display, wherein the computer is further configured to select a focal-plane of the 3D display using the updated convergence distance.

8. The computer according to claim 6, wherein the computer is further configured to subsequently determine a further object of the visualized objects using the updated convergence distance.

9. The computer according to claim 6, wherein the computer is further configured to obtain the gaze convergence distance by calculating a depth from an eye to a convergence point or by calculating a depth from a normal between the first eye and the second eye to the convergence point.

10. The computer according to claim 6, wherein the computer is further configured to obtain the gaze convergence distance by using an interocular distance (IOD), indicating a distance between the eyes of the user, and an interpupillary distance (IPD), indicating a distance between the pupils of the user, and a predetermined function.

11. A computer program comprising computer-executable instructions for causing a computer, when the computer-executable instructions are executed on processing circuitry comprised in the computer, to perform the steps of:
visualizing a plurality of objects, each at a known 3D position, using a 3D display,
determining an object of the visualized objects at which a user is watching based on a gaze point,
obtaining a gaze convergence distance indicative of a depth the user is watching at,
obtaining a reference distance based on the 3D position of the determined object, calculating an updated convergence distance using the obtained gaze convergence distance and the reference distance.

12. A computer program product comprising a computer-readable storage medium, the computer-readable storage medium having the computer program according to claim 11 embodied therein.
